(19) United States
(12) Patent Application Publication
(10) Pub. No.: US 2022/0405868 A1
(43) Pub. Date: Dec. 22, 2022

(54) Automatic Restaurant Ordering System

(71) Applicant: Scott C Harris, San Diego, CA (US)

(72) Inventor: Scott C Harris, San Diego, CA (US)

(21) Appl. No.: 17/304,230

(22) Filed: Jun. 16, 2021

(51) Int. Cl. G06Q 50/12; G06K 7/14

(52) U.S. Cl. CPC G06Q 50/12; G06K 7/1417

(57) ABSTRACT

An AI based moderator system for an electronic conference.

### BACKGROUND

Since the initiation of the Covid 19 pandemic, it has become conventional to provide codes in restaurants, in place of paper menus.

Users can scan the codes, and read the menu on their smart phones, and order from a server.

### SUMMARY OF THE INVENTION

An embodiment describes the use of a location specific code to enable display of a menu, tied to the specific location of the code.

Embodiments describe using this code in the context of ordering from a menu in a restaurant, however it should be understood that this code can alternatively be used with any item that can be purchased from any kind of catalog or other device.

An embodiment describes use of location specific code for carrying out the purchasing.

### BRIEF DESCRIPTION OF THE DRAWINGS

In the Drawings:

FIG. 1 shows a block diagram of operation with a process flow of a first embodiments;

FIG. 2 illustrates further details of the process flow of ordering using a location specific code;

FIG. 3 illustrates an alternative way of determining location to obtain location specificity to be associated with the code.

### DETAILED DESCRIPTION

In order to avoid the use of paper menus, it has become conventional to provide a code for a user to scan with their smart phone. The codes are conventionally a QR code. The QR code translates to an Internet-based URL to a website that returns the menu of the restaurant. Of course, other codes can be used in place of a QR code.

The user can read from the menu and order from the server in the conventional way.

In a conventional system, the same QR code is located everywhere in the restaurant, and the user scans the QR code that is anywhere in the restaurant, to obtain the menu.

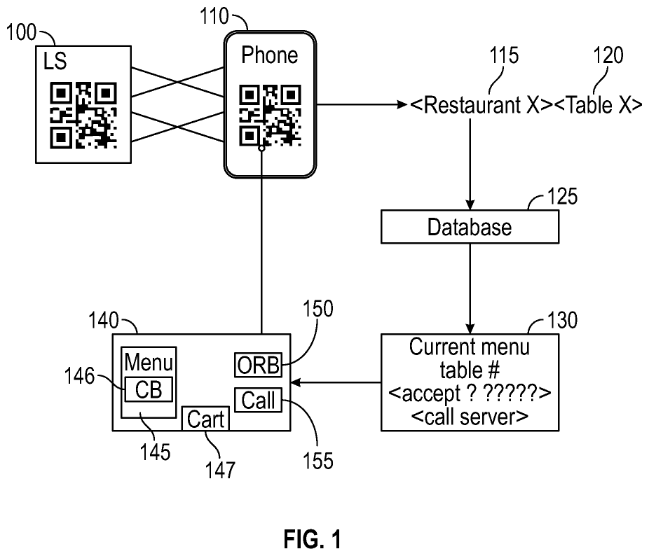

According to an embodiment, a location specific QR code 100, shown in FIG. 1, is used.

The QR code is “scanned” using the camera on a phone 110. The QR code translates into a URL, with two different parts: a part for the restaurant specific menu element 115, and the part for the specific location of the QR code, shown as the <table X> 120. This can alternatively be seat specific.

This translated information from the QR code is then used in conjunction with a database at 125, to return a current menu/ordering system to the user at 130, as part of a system that also includes information indicating the table number. This causes, as shown in 140, the menu to be displayed as 145 on the display of the phone, where each item on the menu such as 146 can be selected, and added to the cart shown as 147.

Once the user is finished adding all items to the cart, the user can press the order button at 150, which allows the user to enter payment information, and to order the items. Since part of the order includes the table number, items will automatically be delivered to the table number, from which they are ordered, as read from the QR code.

In an embodiment, some users would prefer to actually have a server, and for those users, a “call” button can be located, so that the user can call over a conventional waiter, to the table indicated by the code.

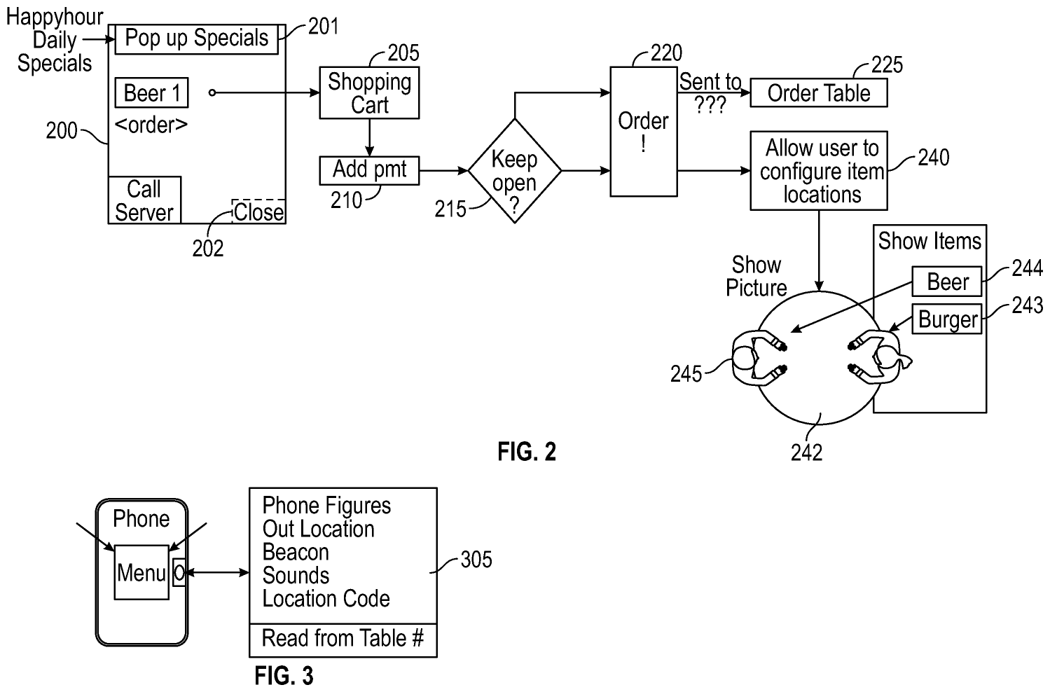

FIG. 2 illustrates further detail on the ordering flow. The screen 200 shows different things that can be added to the shopping cart 205.

This system can be not only location specific but also time specific, so that as part of the menu, there can be pop up specials shown as 201, such as happy hour specials, or daily specials. The user can click on any of these items, and add them to the shopping cart shown as 205. The user can also receive different menus based on their location—e.g., if the location, table x, is in the dining room, the user does not get the bar-only menu.

Once the user adds items to the shopping cart, the user is given the option to add a payment method at 210, and asked whether they want to keep the invoice open at 215. Either way, the order can be executed at 220. Once the order is executed, the information is sent to the main kitchen, which includes information, as shown as 225, about both the order, and the table number.

At any point, therefore, the user can again add something to the cart from the screen 200, and order again at 220. This system contemplates that this is used with an app or other kind of payment system, so that the user does not need to add their payment information each time, this being something the app will typically already store.

This in essence becomes an alternative to the style of restaurants where users have to order at a counter. In that style of restaurants, users order at a counter, get a number, that they leave on their table, and the food is delivered to the table. In this system, however, the user can continue to order on their phones, and have the food delivered. This is no more trouble for the restaurant, and gives users a more individually served feeling, since they do not need to order at a counter.

In an embodiment, after purchasing the food, the user is given the option at 240 to configure specific item locations so that a food deliverer is given specific seat information that the food should be delivered to. This can be done, for example, using a list of items such as shown in 243, where each item in the list is annotated with a seat number.

In an alternative embodiment, a picture of the table 242 is shown, along with different seats. This may be a picture of the table that may be a stock picture associated with the location specific code. Alternately, it may be an actual photo of the picture of the table taken using photo surveillance equipment.

In this embodiment, the picture of the table is annotated by the user dragging items from the food list 243 of previously-ordered food items, onto the picture 242. For example, the user is shown dragging the item 244 for a beer, onto the location 245 on the picture. In this way, this provides instructions to the food deliver about where each item should be delivered. This can be done after the food has been ordered, because there will always be a delay time after the food has been ordered and before the food is delivered.

At any point, the user can initiate the close command at 202, which closes out the invoice, and allows the user to leave without waiting for a server to bring a bill.

The above has described the location specificity as being part of the QR code, so that each QR code, is scanned by the phone to determine location specificity. In an alternative embodiment illustrated in FIG. 3, however, a generic QR code is used with a menu, and the phone itself uses something else to obtain the information of the location of the phone, to send that as part of the ordering or after the ordering. This can, therefore, allow a user to order, and then to specify their seat/location after they select a seat.

The phone can determine its location as shown in FIG. 3, and add this location to the order. This using a beacon, by determining echoes and sounds, or using a location code. For example, the location look code can be a separate code on the table, or can simply be a table number that is located on the table that can be recognized by the program in the phone.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. For example, while the above describes using QR codes, it should be understood that other codes can be scanned, or other ways of obtaining the information can be scanned into the phone. Thus, the present invention is not intended to be limited to the embodiments shown herein but is to be accorded the widest scope consistent with the principles and novel features disclosed herein.

1. A method of ordering food at a restaurant, comprising:
using the personal device, receiving a picture of a code at a location in a restaurant;
in the personal device, converting the picture of the code into information indicative of information representing an online address of a menu of the restaurant, and also information indicative of the location in the restaurant at which the code was located;
displaying the menu received from the online address on the personal device; and using the personal device, receiving information indicative of items to order from the menu, and sending an order of the items from the menu along with the location in the restaurant

2. The method as in claim 1, wherein the code is a single QR code.

3. The method as in claim 2, wherein the QR code translates to a URL that pulls up the restaurant menu, and a table indicator which is indicative of the specific location.

4. The method as in claim 1, wherein the code is a code with information indicative of an Internet address with 2 different parts including a first part with a restaurant specific menu and a 2nd part with a specific location of the code.

5. The method as in claim 3, wherein the specific location of the code comprises a table number.

6. The method as in claim 1, wherein the information indicative of the menu is based on a current time, and is different at a first time than it is at a different second time.

7. The method as in claim 1, further comprising displaying a graphical display on the user phone, and enabling the user to rearrange ordered items according to a specific seat to which the ordered items are to be delivered.

8. The method as in claim 7, wherein the graphical system comprises a picture of the table with seats and a list of items, which can be associated with each of the seats.

9. The method as in claim 8, wherein the picture of the table comprises a real time photo taken of the table.

10. A apparatus for ordering food at a restaurant, comprising:
a personal device, running a program that receives a picture of a code at a location in a restaurant, the program converting the picture of the code into information indicative of information representing an online address of a menu of the restaurant, and also information indicative of the location in the restaurant at which the code was located;
the personal device displaying the menu obtained from the online address;
the personal device, allowing ordering items from the menu; and
the personal device sending an order along with the location from the code.

11. The apparatus as in claim 10, wherein the code is a single QR code.

12. The apparatus as in claim 11, wherein the QR code translates to a URL that pulls up the restaurant menu, and a table indicator which is indicative of the specific location.

13. The apparatus as in claim 11, wherein the code includes information indicative of an Internet address with a first part with a restaurant specific menu and a second part with the location.

14. The apparatus as in claim 13, wherein the location of the code comprises a table number.

15. The apparatus as in claim 11, wherein the information indicative of the menu is based on a current time, and is different at a first time than it is at a different second time.

16. The apparatus as in claim 11, further comprising displaying a graphical display on the user phone, and enabling the user to rearrange ordered items according to a specific seat to which the ordered items are to be delivered.

17. The apparatus as in claim 16. wherein the graphical system comprises a picture of the table with seats and a list of items, which can be associated with each of the seats.

18. The apparatus as in claim 17, wherein the picture of the table comprises a real time photo taken of the table.

19. An apparatus for ordering food at a restaurant, comprising:
a personal device, running a program that receives a picture of a code at a location in a restaurant, the program converting the picture of the code into a URL that pulls up the restaurant menu, and also of a table indicator which is indicative of the specific location in the restaurant;
the personal device displaying the menu obtained from the URL;
the personal device, allowing ordering items from the menu; and
the personal device sending an order along with the table indicator from the code.

20. The apparatus as in claim 19, where the program also allows, after sending the order, displaying a list of items from the order, and associating items on the list with specific seats at a table associated with the table indicator.
